(19) United States
(12) Patent Application Publication
(10) Pub. No.: US 2022/0083958 A1
(43) Pub. Date: Mar. 17, 2022

(54) KIOSK DEVICE HAVING STORAGE BINS

(71) Applicant: Hewlett-Packard Development Company, L.P., Spring, TX (US)

(72) Inventors: Gerold Keith Shelton, Boise, ID (US); Kyle James Nottingham, Boise, ID (US); Matthew Frederickson, Spring, TX (US)

(73) Assignee: Hewlett-Packard Development Company, L.P., Spring, TX (US)

(21) Appl. No.: 17/418,215

(22) PCT Filed: May 8, 2019
(86) PCT No.: PCT/US2019/031246

§ 371 Date: Jun. 24, 2021

(51) Int. Cl. G06Q 10/08; G06Q 20/32; G06Q 20/40; G06Q 20/18

(52) U.S. Cl. CPC G06Q 10/087; G06Q 20/18; G06Q 20/4014; G06Q 20/3278

(57) ABSTRACT

In some examples, a controller includes a processing resource and a memory resource storing instructions to cause the processing resource to determine, via a radio frequency identification (RFID) reader in response to a storage bin of a kiosk being accessed, details regarding an item transiting the storage bin via an RFID tag associated with the item based on a received access request for the storage bin that includes an associated user identity, associate the details regarding the item with a user register associated with the user identity, and update an inventory of the storage bin based on the determined details regarding the item transiting the storage bin.

### BACKGROUND

A kiosk can be used as a structure for storing items. The items can be stored in the kiosk until a user wants to utilize an item from the kiosk. For example, a user can retrieve the item from the kiosk and utilize the item for a particular purpose. In some examples, a user can place the item back in the kiosk.

### BRIEF DESCRIPTION OF THE DRAWINGS

FIG. 1 illustrates an example of a kiosk device having storage bins consistent with this disclosure.

FIG. 2 illustrates an example of a controller of a kiosk device having storage bins consistent with this disclosure.

FIG. 3 illustrates a block diagram of an example system consistent with the disclosure.

FIG. 4 illustrates an example of a method for a kiosk device having storage bins consistent with this disclosure.

### DETAILED DESCRIPTION

In some examples, kiosks can be interactive. As used herein, the term “kiosk” refers to a structure having a storage area. The storage area can be utilized by the kiosk in performing a particular task when a user interacts with a kiosk. For instance, a user can place an item in the kiosk and the kiosk can perform a task with the item. As another example, a user can interact with the kiosk such that the kiosk allows a user to retrieve an item from the kiosk.

As described above, a kiosk can be utilized by a user to place and/or retrieve items. For instance, a kiosk may include a storage bin having computing devices and/or electronic components for the computing devices. A user can interact with the kiosk to retrieve a computing device and/or a component for use with the computing device.

Some kiosks may temporarily allow retrieval of items for use by a user. Continuing with the example from above, the user can interact with the kiosk to retrieve a component for use with the user's computing device. However, the user may have retrieved the component for a defined period of time. Accordingly, the user can then place the component back in the storage bin of the kiosk once the user is finished using the item.

However, tracking inventory of items stored in a kiosk can be challenging. For example, it can be difficult to have an up to date inventory including a type and/or an amount of items stored in the kiosk. Further, users may not always return items rented and/or loaned from a kiosk (e.g., due to forgetfulness, theft, etc.).

Kiosk devices having storage bins, according to the disclosure, can allow for inventory tracking of items included in a kiosk. For example, the inventory of a storage bin, including a total amount of items in a storage bin, the type of items in a storage bin, and/or an amount of and/or types of items that have been removed (e.g., that are loaned out or rented) from the kiosk, can be tracked. This can ensure an accurate inventory list of items included in a kiosk. Further, items can be associated with users such that those users who have items from the kiosk which have not been returned can be notified and/or charged for such items.

FIG. 1 illustrates an example of a kiosk device 102 having storage bins 106-1, 106-2, 106-N consistent with this disclosure. The kiosk 102 can include radio frequency identification (RFID) readers 104-1, 104-2, 104-M (referred to collectively herein as RFID readers 104) and storage bins 106-1, 106-2, 106-N (referred to collectively herein as storage bins 106).

As illustrated in FIG. 1, the kiosk device 102 can include the storage bins 106. As used herein, the term “storage bin” refers to an enclosed space to store an item or items. For example, the storage bins 106 can be enclosed spaces in which to store items, such as the first item 108 and/or the second item 110. In some examples, the storage bins 106 can be drawers, located behind a door, etc. However, although the storage bins 106 are described above as being a drawer or being located behind a door, examples of the disclosure are not so limited. For example, the storage bins 106 can be combinations thereof (e.g., a drawer located behind a door (swinging and/or sliding)), and/or can be any other type of storage bin.

The kiosk device 102 can include RFID readers 104. As used herein, the term “RFID reader” refers to a device used to collect information from an RFID tag using electromagnetic fields. For example, the RFID readers 104 can be used to collect information from RFID tags 109 and/or 111, associated with first item 108 and/or second item 110, respectively, as is further described herein. As used herein, the term “RFID tag” refers to a device including electronically stored information readable by an RFID reader.

The RFID readers 104 can be passive RFID readers. For example, the passive RFID readers 104 can be normally powered off. In response to a particular triggering mechanism, the passive RFID readers 104 can be turned/powered on in order to collect information from an RFID tag, as is further described herein. The triggering mechanism can be, in some examples, sensors detecting a user accessing a particular storage bin of the storage bins 106, among other examples.

As previously described above, a user can access the kiosk device 102. The user can access the kiosk device 102 in order to access items 108, 110 included in the storage bin 106. For example, a user may want to utilize first item 108 and can accordingly gain access to first item 108 by accessing storage bin 106, as is described herein.

In order for a user to access a storage bin of the storage bins 106 of the kiosk device 102, the user can input an access request, as is further described herein. For example, a user may utilize the kiosk device 102 to service a computing device of the user, such as the user's mobile device. For instance, the user's mobile device may have to have a software update, a mechanical part fixed (e.g., a cracked screen), etc. Accordingly, a user can place their computing device in a storage bin of the storage bins 106 of the kiosk device for servicing.

As a result of the servicing, in some examples, a user may have to utilize a particular item such as a particular cable, may be issued a “loaner” computing device (e.g., such as a loaner mobile device while the user's mobile device is being serviced), etc. A user can request access to a storage bin of the storage bins 106 in order to access a cable, a loaner computing device, etc. by inputting an access request into the kiosk device 102. Further, if a user returns a damaged item to the kiosk device 102, the kiosk device 102 can issue another working item of the same item type as the damaged item, as is further described herein. Accordingly, the kiosk device 102 can receive an access request to a storage bin of the storage bins 106. As used herein, the term “access request” refers to a petition/solicitation for an ability/permission for admittance to a storage bin of the storage bins 106. A user can input an access request via an input mechanism (not illustrated in FIG. 1). An input mechanism can include a badge reader, card reader, keypad, touch-screen display, and/or biometric scanner, among other examples of input mechanisms. For example, a user can swipe a badge, security key, and/or access card (e.g., via a badge and/or card reader), enter a passcode (e.g., via a keypad/touch-screen display), enter a biometric input (e.g., such as a facial scan, eye scan, fingerprint, voice input, etc.), among other types of access requests.

The access request can be associated with a user identity. As used herein, the term “user identity” refers to a logical entity used to identify a user on a system. For example, a user identity can be an entity that corresponds to a particular user to identify the particular user for the kiosk device 102.

The controller 114 can grant access to a storage bin of the storage bins 106 based on the user identity. For example, in response to the user identity having access rights to the storage bin(s) 106, the controller 114 can grant access to the storage bin(s) 106. In some examples in which a user may not have access rights to the storage bin(s) 106, the controller 114 can deny access to the storage bin(s) 106.

In some examples, the access request can include an item type. For instance, in some examples a kiosk device such as kiosk device 102 may include multiple items (e.g., first item 108, second item 110) which can be different items.

As used herein, the term “item” refers to any object that can be placed/stored/accessed in storage bin 106. For instance, first item 108 may be a component of a computing device and second item 110 may be a computing device. For example, first item 108 can be, for instance, a cable such as a universal serial bus (USB)-C cable. A user may utilize the first item 108 (e.g., the USB-C cable) for various purposes, but the user may not have the USB-C cable available, so the user can request access to storage bin 106-1 in order to remove the first item 108 from the storage bin 106-1 for use. Accordingly, a user may input an access request for a particular item type, such as a computing device.

Although the first item 108 is described above as being a USB-C cable, examples of the disclosure are not so limited. For example, first item 108 can be a micro-USB and/or Lightning cable. Additionally, although first item 108 is described as being a USB cable, examples of the disclosure are not so limited. For example, the first item 108 can be any other component of a computing device, and/or can be a computing device itself. As used herein, the term “computing device” can be, for example, a laptop computer, a desktop computer, or a mobile device (e.g., a smart phone, tablet, personal digital assistant, smart glasses, a wrist-worn device, etc.), among other types of computing devices. As used herein, the term “mobile device” refers to a device that are (or can be) carried and/or worn by a user. A mobile device can include a phone (e.g., a smart phone), a tablet, a personal digital assistant (PDA), smart glasses, and/or a wrist-worn device (e.g., a smart watch), among other types of mobile devices. Further, second item 110 can be any component of a computing device and/or can be a computing device itself, including but not limited to the examples of computing devices and components thereof described above.

The first item 108 can include an RFID tag 109 associated with the first item 108. For example, the RFID tag 109 can be attached to the first item 108 (e.g., via a zip-tie, Velcro tie, and/or other attachment mechanism). The RFID tag 109 can be associated with the first item 108. For example, the RFID tag 109 can be attached to the first item 108 (e.g., via a zip-tie, Velcro tie, and/or other attachment mechanism). The RFID tag 109 can be associated with the first item 108. Similarly, the second item 110 can include an attached RFID tag 111 associated with the second item 110.

Controller 114 can determine, using an RFID reader of the kiosk device 102, an inventory of items included in a storage bin. As used herein, the term “inventory” refers to a listing of an amount and/or type of an item. For example, the inventory of storage bin 106-1 can include the first item 108.

Although the storage bin 106-1 (e.g., or storage bins 106, generally) is described above as including one item (e.g., first item 108), examples of the disclosure are not so limited. For example, the storage bins 106 can include more than one item.

The kiosk device 102 can include three storage bins 106-1, 106-2, 106-N. As illustrated in FIG. 1, each of the three storage bins 106-1, 106-2, 106-N can have an associated RFID reader 104-1, 104-2, 104-M. Additionally, each item included in each of the three storage bins 106-1, 106-2, 106-M can have an associated RFID tag.

In order to determine an inventory of items included in storage bins 106, the controller 114 can cause the RFID readers 104 associated with each storage bin to scan for (e.g., attempt to read) the RFID tags associated with each item included in the storage bins 106. In response to the RFID readers 104 reading RFID tags of each of the items included in the storage bins 106, the controller 114 can determine an inventory of each storage bin 106-1, 106-2, 106-N of the kiosk device 102. For example, in response to RFID reader 104-1 reading six RFID tags included in storage bin 106-1, the controller 102 can determine that storage bin 106-1 includes six items, in response to RFID reader 104-2 reading twenty RFID tags included in storage bin 106-2, the controller 102 can determine that storage bin 106-1 includes twenty items, and in response to RFID reader 104-M reading four RFID tags included in storage bin 106-N, the controller 102 can determine that storage bin 106-N includes four items.

As illustrated in FIG. 1, the kiosk device 102 can include three RFID readers 104-1, 104-2, 104-M each corresponding to a storage bin 106-1, 106-2, 106-N, respectively. However, examples of the disclosure are not so limited. For example, the kiosk device 102 can include less than three RFID readers 104-1, 104-2, 104-M or more than three RFID readers 104-1, 104-2, 104-M.

Additionally, as illustrated in FIG. 1, each RFID reader 104 can include a scannable coverage area to read RFID tags corresponding to each storage bin 106. That is, RFID reader 104-1 can include a coverage area corresponding to storage bin 106-1, RFID reader 104-2 can include a coverage area corresponding to storage bin 106-2, and RFID reader 104-M can include a coverage area corresponding to storage bin 106-N. However, examples of the disclosure are not so limited. For example, RFID reader 104-2 can include a coverage area corresponding to storage bins 106-1 and 106-2 and/or 106-N. In other words, the kiosk device 102 can include an amount of RFID readers 104 having coverage areas that don't necessarily correspond to a particular storage bin 106. That is, one RFID reader 104 can cover one storage bin 106 or can cover more than one storage bin 106.

The controller 114 can determine an amount of the type of item included in each storage bin 106. For example, RFID reader 104-1 can scan storage bin 106-1 for items having associated RFID tags. For instance, first item 108 can be located in storage bin 106-1 and have associated RFID tag 109. The RFID tag 109 can include electronically stored information including the type of item that first item 108 is. For instance, the RFID tag 109 can store information that indicates first item 108 is a computing device component (e.g., a USB-C cable). Storage bin 106-1 may have eight USB-C cables each having an associated and attached RFID tag and ten Lightning cables each having an associated and attached RFID tag. RFID reader 104-1 can scan storage bin 106-1 and controller 114 can determine that, based on RFID reader 104-1 scanning the eight RFID tags associated with the eight USB-C cables and the ten RFID tags associated with the ten Lightning cables, that storage bin 106-1 includes eight USB-C cables and ten Lightning cables.

The controller 114 can, in some examples, prevent access to a storage bin of the storage bins 106 in response to an amount of the item type being less than a threshold amount. As previously described herein, the kiosk device 102 can receive an access request which can include an item type. For example, a user may request a USB-C cable. The threshold amount of an item may be one. For instance, storage bin 106-1 may have zero USB-C cables and, in response to the amount of USB-C cables included in storage bin 106-1 (e.g., zero) being less than the threshold amount of USB-C cables (e.g., one), the controller 114 can prevent access to the storage bin 106-1.

Although the threshold amount of items in a storage bin 106 is described above as being one, examples of the disclosure are not so limited. For example, the threshold amount of items can be greater than one.

In an example in which an amount of the items is less than a threshold amount, controller 114 can transmit a re-stock notification. For example, if an amount of the item included in a storage bin (e.g., zero items) in of the storage bins 106 is less than a threshold amount (e.g., one item), the controller 114 can cause a re-stock notification to be sent to a kiosk administrator to cause the kiosk administrator to add items to the storage bin.

In some examples, the controller 114 can prevent access to a storage bin of the storage bins 106 in response to an item type not being included in the determined inventory of items included in the storage bin of the storage bins 106. For example, a user may request a USB-C cable. In response to the inventory of items included in storage bins 106 including zero USB-C cables, the controller 114 can prevent access to the storage bin of the storage bins 106.

In some examples, the kiosk device 102 may be utilized in a business environment. For example, the kiosk device 102 may be used in an office, a warehouse, etc. Within such business environment, employees and/or other users may be issued a computing device having associated computing device components which may be utilized for work purposes, for instance. In some examples a device service bulletin can be executed such that updated computing devices are issued to employees and/or other users (e.g., a new and/or upgraded model of mobile device is utilized). In such an example, an item update can be transmitted to the kiosk device 102.

In some examples, the storage bins 106 can include items that, after wear and tear, may have to be replaced. For example, first item 108 may be a computing device component such as a USB-C cable and after many uses, the USB-C cable has to be replaced (e.g., due to wear and tear). For instance, when a user returns first item 108 to the storage bin 106-1, the user can input to the kiosk device 102 a replacement recommendation that the item should be replaced (e.g., Recommend to be replaced) and can give a reason or reasons for doing so (e.g., item does not function properly at all times, item does not function at all, etc.). In response to the replacement recommendation for the item being input to the kiosk device 102, the controller 114 can transmit a notification to a kiosk administrator, where the notification informs the kiosk administrator to order a replacement item (e.g., a replacement USB-C cable). In some examples, the kiosk device 102 can transmit an order request in response to the replacement recommendation being input to the kiosk device 102. For example, the kiosk device 102 may transmit the order request to cause the replacement item to be ordered (e.g., automatically, in response to an instruction/input from the user and/or from the kiosk administrator, etc.). In an example in which the user still has to utilize an item that is a same item type as the item that the user has returned as damaged, the kiosk device 102 can issue another of the item to the user in response to the user inputting the replacement recommendation to the kiosk device 102. In some examples, the pre-determined allotment time for the newly issued item can be the same as the pre-determined allotment time for the returned and damaged item, extending an amount of time the user can utilize the item (e.g., pre-determined allotment time for damaged item was 5 days; pre-determined allotment time for new item is an additional 5 days). In some examples, the pre-determined allotment time for the newly issued item can be an amount of time that would have been left had the user not returned the damaged item (e.g., pre-determined allotment time for damaged item was 5 days and user returned/added the item to the storage bin after 3 days; pre-determined allotment time for new item is 2 days). The pre-determined allotment time is further described herein.

The kiosk device 102 can compare the inventory of storage bins 106 to determine whether the inventory exists for the newly issued device service bulletin. For example, the new and/or upgraded models of computing devices may have various associated components that may or may not work with older versions of the computing devices. Accordingly, the kiosk device 102 can compare the inventory of the storage bins 106 to determine details about the items included in the storage bins 106 to determine whether inventory exists for the new and/or updated computing devices. In an instance in which computing device components currently located in the storage bins 106 are compatible with the new and/or upgraded model of computing devices, the kiosk device 102 can transmit a notification indicating as such. Additionally, if computing device components currently located in the storage bins 106 are not compatible with the new and/or upgrade model of computing devices, the kiosk device can transmit a notification indicating as such. The notification can alert a kiosk administrator to update the items included in the storage bins 106 so that the items are compatible with computing devices that are currently in use.

The controller 114 can determine, via the RFID reader 104 in response to the storage bin 206 being accessed, details regarding an item transiting the storage bin via an RFID tag associated with the item. As used herein, the term “transiting” refers to an item being placed in the storage bin 106 and/or being removed from the storage bin 106. For example, a user can input an access request into the kiosk device 102 and the controller 114 can grant access to the storage bin 106 for the user. The user can remove the first item 108 from the storage bin 106-1. As a result of the first item 108 being removed from or being added to (e.g., transiting) the storage bin 106, the controller 114 can determine details regarding the first item 108 via the RFID reader 104-1 and the RFID tag 109 associated with the first item 108.

As used herein, the term “details” refers to characteristics about items included in the storage bins 106. For example, the controller 114 can determine details regarding the items transiting the storage bins 106 including the type of item transiting the storage bins 106, an amount of the item transiting the storage bins 106, time and/or date the item transited the storage bins 106, and/or whether the item is being added to the storage bins 106 and/or being removed from the storage bins 106, among other details regarding items transiting the storage bins 106, as is further described herein.

The controller 114 can determine the details regarding the item 108, 110 transiting the storage bins 106 by determining a type of the item 108, 110. The type of the item can be included in the RFID tag associated with the item. In some examples, the first item 108 can be a Micro-USB cable, and the RFID tag 109 can include the cable type of the first item 108 as a Micro-USB cable, among other examples. In some examples, the second item 110 can be a mobile device, and the RFID tag 111 can include the brand name, model number, etc. of the second item 110 as the mobile device, among other examples. Accordingly, the RFID readers 104 can determine the type of the item 108, 110 based on the RFID readers 104 scanning (e.g., in response to the item 108, 110 being added to the storage bins 106) or not being able to scan (e.g., in response to the items 108, 110 being removed from the storage bins 106) the RFID tags 109, 111 associated with the first item 108 and the second item 110, respectively, as is further described herein.

The controller 114 can determine the details regarding the item 108, 110 transiting the storage bins 106 by determining whether the item is removed from the storage bins 106 or added to the storage bins 106. The details regarding whether the item 108, 110 is added to and/or removed from the storage bins 106 can be determined based on a signal from the RFID tag 109, 111 associated with the item 108, 110, respectively, read by the RFID readers 104.

For example, first item 108 can be removed from the storage bin 106-1 by a user. While the first item 108 is located in the storage bin 106-1, the RFID tag 109 associated with the first item 108 is readable by the RFID reader 104-1. When the storage bin 106-1 is accessed and the first item 108 is removed from the storage bin 106-1, the RFID tag 109 associated with the first item 108 can be moved a threshold distance away from the RFID reader 104-1 such that the RFID reader 104-1 can no longer read the RFID tag 109. Accordingly, the controller 114 can determine that first item 108 has been removed from storage bin 106-1.

In some examples, the RFID reader 104-1 can scan for (e.g., attempt to read) the RFID tag 109 in response to the storage bin 106-1 being closed. In response to the RFID reader 104-1 not being able to read RFID tag 109, the controller 114 can determine the details regarding first item 108 transiting the storage bin 106-1 (e.g., first item 108 was removed from the storage bin 106-1). In some examples, RFID reader 104-1 can scan for RFID tag 109 and compare RFID tag read by the RFID reader 104-1 to a previous inventory. For instance, as previously described above, the RFID reader 104-1 can update the inventory of the storage bin 106-1 in response to granting access to the storage bin 106-1. The RFID reader 104-1 can complete the scan for RFID tag 109 and compare with the previous inventory performed when access was granted to the storage bin 106-1 to determine that RFID tag 109 is not readable (e.g., as first item 108 has been removed from the storage bin 106-1). Accordingly, the controller can determine that the first item 108 was removed from the storage bin 106-1.

As another example, second item 110 can be added to the storage bin 106-N by a user. For example, a user may have accessed storage bin 106-N in the past to remove a mobile device (e.g., second item 110) and is now attempting to return the second item 110 to the kiosk device 102. While the second item 110 is located outside of the storage bin 106-N, the RFID tag 111 associated with the second item 110 is not readable by the RFID reader 104-M. When the storage bin 106-N is accessed and the second item 110 is added to the storage bin 106-N, the RFID tag 111 associated with the second item 110 can be moved to within a threshold distance from the RFID reader 104-M such that the RFID reader 104-M can read the RFID tag 111. Accordingly, the controller 114 can determine that second item 110 has been added to the storage bin 106-N.

In some examples, the RFID reader 104-M can scan for (e.g., attempt to read) the RFID tag 111 in response to the storage bin 106-N being closed. In response to the RFID reader 104-M being able to read RFID tag 111, the controller 114 can determine the details regarding the second item 110 transiting the storage bin 106-N (e.g., second item 110 was added to the storage bin 106-N). In some examples, RFID reader 104-M can scan for RFID tag 111 and compare RFID tags read by the RFID reader 104-M to a previous inventory. For instance, as previously described above, the RFID reader 104-M can update the inventory of the storage bin 106-N in response to granting access to the storage bin 106-N. The RFID reader 104-M can compare the scan for RFID tag 111 and compare with the previous inventory performed when access was granted to the storage bin 106-N to determine that RFID tag 111 is readable (e.g., as second item 110 has been added to the storage bin 106-N). Accordingly, the controller can determine that the second item 110 was added to the storage bin 106-N.

In some examples, an RFID tag such as the RFID tag 111 may become separated from its associated item (e.g., second item 110). For example, a user may be utilizing the second item 110 and during use, the RFID tag 111 becomes separated from the second item 110. In such an example, when a user is to add the second item 110 to storage bin 106-N, the user can input an RFID tag lost input to the kiosk device 102. As used herein, the term “RFID tag lost input” refers to an input to the kiosk device 102 that indicates the RFID tag associated with an item has become separated from the item. Accordingly, the controller 114 can determine the details regarding the item (e.g., second item 110) including determining that second item 110 is conditionally added to the storage bin 106-N. The controller 114 can determine that second item 110 is conditionally added to the storage bin 106-N because RFID reader 104-M is unable to read the RFID tag 111 associated with the second item 110, since the RFID tag 111 has become separated from the second item 110 and may be lost. Accordingly, the controller 114 can transmit an RFID tag lost notification in response to receiving the RFID tag lost input. The RFID tag lost notification may be transmitted to a kiosk administrator such that the kiosk administrator can manually determine whether the second item 110 has been returned to the storage bin 106-N and so that a new RFID tag can be associated with the second item 110. In some examples, the RFID tag lost notification may be transmitted to the user and/or to the user's supervisor, etc.

The controller 114 can determine the details regarding the item 108, 110 transiting the storage bins 106 by determining details regarding the item 108, 110 including a time and/or a date an item was removed from a storage bin of the storage bins 106 and/or an item was added to a storage bin of the storage bins 106. For example, a user may have removed first item 108 from storage bin 106-1 at 4:30 PM on Friday, Apr. 26, 2019. The controller 114 can determine the time and/or date the first item 108 was removed as being 4:30 PM on Friday, Apr. 26, 2019.

In an example in which an item (e.g., such as first item 108) is removed from a storage bin, the controller 114 can assign a pre-determined allotment time to the item. As used herein, the term “allotment time” refers to an amount of time appropriated for a particular action. For example, the controller can assign a pre-determined allotment time to the first item 108 of five days. However, examples of the disclosure are not so limited. For example, the pre-determined allotment time for first item 108 can be less than five days (e.g., eight hours) or more than five days (e.g., thirty days).

In some examples, the pre-determined allotment time can be based on the item type of the item. For example, as previously described above, the first item 108 can be a computing device. Accordingly, the computing device may be assigned a pre-determined allotment time of 2 days, whereas the pre-determined allotment time of a different item such as a computing device component (e.g., a USB-C cable) may be 5 days.

In some examples, the pre-determined allotment time may be based on an expected length of service of a device being serviced. For example, second item 110 may be a user's mobile device that is to be serviced (e.g., a software update, fixing a mechanical part, etc.), and the first item 108 may be a temporary loaner mobile device for the user to utilize while the user's mobile device is being serviced. The pre-determined allotment time for the first item 108 can be based on the expected length of the service (e.g., the software update, fixing a mechanical part, etc.) of the user's mobile device (e.g., second item 110). For example, the pre-determined allotment time for first item 108 may be 2 days, as it is expected to take 2 days to fix a cracked screen of the user's mobile device (e.g., second item 110). In an example in which the expected 2 days is exceeded (e.g., due to a delay in fixing the cracked screen), the pre-determined allotment time can be extended. A notification can be transmitted to the temporary loaner mobile device (e.g., first item 108) to notify the user that the allotment time for first item 108 is extended.

In some examples, the kiosk device 102 can receive a request to extend the pre-determined allotment time for an item. For example, first item 108 may include a pre-determined allotment time of 2 days. A user can input a request to extend the pre-determined allotment time, including an amount of extension time and, in response, the kiosk device 102 can modify the allotment time to extend the allotment time for the item. Similarly, in some examples a user can input a request to reduce the pre-determined allotment time and, in response, the kiosk device 102 can modify the allotment time to reduce the allotment time for the item.

The controller 114 can associate the details regarding the item transiting the storage bins 106 with a user register associated with the user identity included in the access request. As used herein, the term “user register” refers to a record of events. For example, as previously described above, the details regarding an item transiting a storage bin of the storage bins 106 can include a type of an item, whether an item is removed from the storage bins 106, whether an item is added to the storage bins 106, an amount of the item added/removed, an allotment time of an item removed from the storage bins 106, costs associated with not returning an item removed from the storage bins 106, etc.

As an example, a user may request access by an access request including a user identity associated with the user to a storage bin of the storage bins 106 of the kiosk device 102 to remove first item 108 (e.g., a USB-C cable). The user identity can include an associated user register. If the user is granted access and the user removes the USB-C cable from storage bin 106-1, the controller 114 logs in the user register associated with the user identity the type of item removed from storage bin 106-1 (e.g., a USB-C cable), the amount of the item (e.g., 1 USB-C cable), the time and date the item was removed from the storage bin 106-1 (e.g., Friday, Apr. 26, 2019), and/or the pre-determined allotted time for the USB-C cable (e.g., 3 days), among other details.

Associating the details regarding the item transiting the storage bins 106 with a user register associated with the user identity included in the access request can allow for inventory tracking of items included in the storage bins 106. For example, a kiosk administrator can easily determine a user associated with an item 108, 110 which has been removed from the storage bins 106, how many items 108, 110 the user has removed, whether the items 108, 110 have been returned, etc. Additionally, the kiosk administrator can determine a user associated with an item 108, 110 who last removed the item 108, 110 in the event the item 108, 110 is damaged, destroyed, etc.

Based on the determined details regarding the item 108, 110 transiting the storage bins 106, the controller 114 can update an inventory of the storage bins 106. For example, in response to the controller 114 determining first item 108 was removed from storage bin 106-1, the controller 114 can update the inventory of the storage bin 106-1 to reflect the removal of the first item 108 from the storage bin 106-1. Additionally, in response to the controller 114 determining the second item 110 was added to the storage bin 106-N, the controller 114 can update the inventory of the storage bin 106-N to reflect the addition of the second item 110 to the storage bin 106-N.

The controller 114 can cause the determined details regarding the item transiting the storage bins 106 to be displayed on a display. The display can be a display included on the kiosk device 102 and/or the display can be a display included on a user's mobile device, among other displays. For instance, in some examples the controller 114 can cause the details to be displayed on a local display included on the kiosk device 102. In some examples, the controller 114 can cause the details to be transmitted to a user's mobile device to be displayed on the display of the user's mobile device.

As described above, in an example in which an item (e.g., such as first item 108) is removed from a storage bin such as storage bin 106-1, the controller 114 can assigned a pre-determined allotment time to the item, as well as log the time and/or date the item was removed from the storage bin. For example, a user may remove first item 108 on Friday, April 26 at 4:30 PM, and the first item 108 may have a pre-determined allotment time of 5 days. The controller 114 can transmit a notification to a computing device associated with the user identity in response to a first threshold amount of time passing since the item was removed from the storage bin. For example, after 4 days having passed, the controller 114 can transmit a notification to a user's mobile device. The notification can warn the user they have 1 remaining day left before the first item 108 has to be returned to the kiosk device 102. In some examples, the notification can be transmitted to the user's supervisor/supervisor's computing device.

In an example in which a second threshold amount of time passes since the item was removed from the storage bin, the controller 114 can generate a monetary charge in the user register associated with the user identity. Continuing with the example above, the user fails to add the first item 108 back to the storage bin 106-1 after a second threshold amount of time passes. The second threshold amount of time can be the pre-determined allotment time for the item. In other words, the user may fail to add the first item 108 back to the storage bin 106-1 after the 5 days of allotment time for the first item 108. The controller 114 can generate a monetary charge in the user register associated with the user identity of the user who removed first item 108 from the storage bin 106-1.

In some examples, the monetary charge can be a charge for the value of the item. For example, if the first item 108 removed from the storage bin 106-1 was a computing device with a value of $500, the controller 114 can generate a monetary charge for $500 in the user register associated with the user identity of the user who removed the first item 108 from the storage bin 106-1.

In some examples, the monetary charge can be a late-fee penalty for every time period exceeded after the pre-determined allotment time. For example, the controller 114 can generate a late-fee penalty (e.g., $5) in the user register associated with the user identity of the user who removed the first item 108 from the storage bin 106-1 for every day exceeding the pre-determined allotment time. In some examples, the late-fee penalty can increase for every day exceeding the pre-determined allotment time (e.g., the late-fee penalty for one day is $5, for two days is $6, for three days is $7, etc.) The late-fee penalty may increase up to the value of the item, in some examples.

The controller 114 can transmit a notification to a computing device associated with the user identity in response to the pre-determined allotment time passing since the item was removed from the storage bin in an example in which the pre-determined allotment time (e.g., the second threshold amount of time) passes since the item was removed from the storage bin. For example, after 5 days having passed (e.g., the pre-determined allotment time), the controller 114 can transmit a notification to a user's mobile device. The notification can warn the user they are being assessed the monetary charge for not returning the item to the kiosk device 102 within the pre-determined allotment time. In some examples, the notification can be transmitted to the user's supervisor/supervisor's computing device.

As previously described above, an item such as second item 110 can be added to the storage bins 106. In some examples in which a user adds an item to the storage bin after a second threshold of time (e.g., after the pre-determined allotment time), the controller 114 can modify the monetary charge in the user register associated with the user identity. In some examples, the controller 114 can reduce the monetary charge of the value of the item (e.g., reduce a monetary charge of $500 to $10) such that the monetary charge reflects a late-fee penalty instead of the value of the item. In some examples, the reduced monetary charge can be a percentage of the monetary charge, where the percentage increases for every time period exceeded after the pre-determined allotment time, among other examples.

Once an item has been added to the storage bins 106 following removal of the item from the storage bins 106, the controller 114 can associate a wait time for the item in the user register associated with the user identity. As used herein, the term “wait time” refers to an amount of time in which a particular user is prohibited from removing an item from a storage bin. For example, a user may remove a USB-C cable from storage bin 106-1 and after the pre-determined allotment time having been exhausted, returns the USB-C cable to storage bin 106-1. The controller 114 can associate a wait time (e.g., 5 days) to the user register associated with the user identity of the user who removed the USB-C cable. Accordingly, the wait time can prevent the user from continuously removing and returning the USB-C cable.

The controller 114 of the kiosk device 102 can generate an alert in response to an item being removed from a storage bin of the storage bins 106 that does not have the item type included in the access request. In some examples, a user may request access to storage bin 106-1 to remove a USB-C cable but removes a Lightning cable. In response, the controller 114 can generate an alert to alert the user of a non-compliant item removal from the storage bin 106-1. The alert may be sent to a computing device associated with the user identity of the user, a computing device associated with the user's supervisor, etc. In some examples, the user identity associated with the user may not have access rights to a particular item (e.g., a laptop) but the user removes the item anyway. In response, the controller 114 can generate an alert to alert the user of a non-compliant item removal from the storage bin 106-1. The alert may be sent to a computing device associated with the user identity of the user, a computing device associated with the user's supervisor, etc.

Kiosk device 102 can receive a reservation request for an item. As used herein, the term “reservation request” refers to a petition/solicitation to withhold an item from removal from a storage bin of the storage bins 106 from users other than a requesting user. For example, a user may input a reservation request for first item 108 in storage bin 106-1. If another user inputs an access request for first item 108 in storage bin 106-1, the kiosk device 102 can prevent access to the storage bin 106-1 to the another user such that the another user cannot remove the first item 108.

When a kiosk device such as the kiosk device 102 is initially setup, the storage bins 106 have to be stocked with items. Additionally, during use of the kiosk device 102, the storage bins 106 may have to be re-stocked with items. Accordingly, a kiosk administrator can cause the kiosk device 102 to enter a kiosk device service mode. During the kiosk device service mode, a kiosk administrator can adjust the inventory of the storage bins 106. Adjusting the inventory of the storage bins 106 can include adding items to the storage bins 106 and associating each of the added items to the storage bins 106 with RFID tags. The RFID tag information can include a brand name of the item, a model number of the item, etc. The RFID tag information of each of the RFID tags and their associations (e.g., the items they are associated with) can be stored in an inventory database, which may be local to the kiosk device 102 and/or located external to the kiosk device 102, where the kiosk device 102 can be in communication with the external database via a network relationship (e.g., a local area network (LAN), wide area network (WAN), personal area network (PAN), a distributed computing environment (e.g., a cloud computing environment), storage area network (SAN), Metropolitan area network (MAN), a cellular communications network, Long Term Evolution (LTE), visible light communication (VLC), Worldwide Interoperability for Microwave Access (WiMAX), infrared (IR) communication, Public Switched Telephone Network (PSTN), radio waves, and/or the Internet, among other types of network relationships). In some examples, the kiosk administrator can remove items from the storage bins 106 and correspondingly, remove RFID tag information and their associations of the RFID tags associated with the removed items.

Kiosk devices having storage bins, according to the disclosure, can allow for items to be distributed and/or received from users. The inventory of the items included in the storage bins of the kiosks can be easily tracked which can ensure an accurate inventory list of the items associated with the kiosk device. Further, items can be associated with users such that users can be notified about and/or charged for items which have not been returned or are returned in a damaged or non-functioning condition.

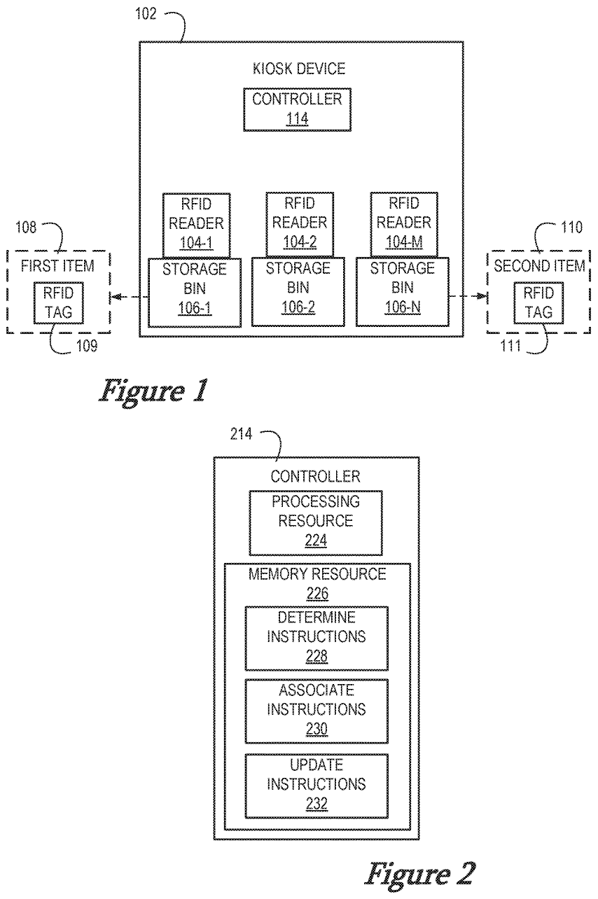

FIG. 2 illustrates an example of a controller 214 of a kiosk device having storage bins consistent with this disclosure. As described herein, the controller 214 may perform functions related to kiosk having storage bins. Although not illustrated in FIG. 2, the controller 214 may include a processor and a machine-readable storage medium. Although the following descriptions refer to a single processor and a single machine-readable storage medium, the descriptions may also apply to a system with multiple processors and multiple machine-readable storage mediums. In such examples, the controller 214 may be distributed across multiple machine-readable storage mediums and the controller 214 may be distributed across multiple processors. Put another way, the instructions executed by the controller 214 may be stored across multiple machine-readable storage mediums and executed across multiple processors, such as in a distributed or virtual computing environment.

Processing resource 224 may be a central processing unit (CPU), a semiconductor-based microprocessor, and/or other hardware devices suitable for retrieval and execution of machine-readable instructions 228, 230, 232 stored in a memory resource 226. Processing resource 224 may fetch, decode, and execute instructions 228, 230, 232. As an alternative or in addition to retrieving and executing instructions 228, 230, 232, processing resource 224 may include a plurality of electronic circuits that include electronic components for performing the functionality of instructions 228, 230, 232.

Memory resource 226 may be any electronic, magnetic, optical, or other physical storage device that stores executable instructions 228, 230, 232 and/or data. Thus, memory resource 226 may be, for example, Random Access Memory (RAM), an Electrically-Erasable Programmable Read-Only Memory (EEPROM), a storage drive, an optical disc, and the like. Memory resource 226 may be disposed within controller 214, as shown in FIG. 2. Additionally, memory resource 226 may be a portable, external or remote storage medium, for example, that causes controller 214 to download the instructions 228, 230, 232 from the portable/external/remote storage medium.

The controller 214 may include instructions 228 stored in the memory resource 226 and executable by the processing resource 224 to determine, via an RFID reader in response to a storage bin being accessed, details regarding an item transiting the storage bin via an RFID tag associated with the item based on a received access request for the storage bin that includes an associated user identity. For example, the controller 214 can determine a type of an item, whether an item is removed from the storage bins, whether an item is added to the storage bins, an amount of the item added/removed, an allotment time of an item removed from the storage bins, costs associated with not returning an item removed from the storage bins, etc. The RFID reader can determine the details regarding the item transiting the storage bin based on a signal from the RFID tag read by the RFID reader.

The controller 214 may include instructions 230 stored in the memory resource 226 and executable by the processing resource 224 to associate the details regarding the item with a user register associated with the user identity. For example, the user register can include associated details regarding the item which can allow for easy inventory tracking of items included in the storage bins, whether they are being utilized, etc.

The controller 214 may include instructions 232 stored in the memory resource 226 and executable by the processing resource 224 to update an inventory of the storage bin based on the determined details regarding the item transiting the storage bin. For example, in response to the controller 214 determining a first item was removed from the storage bin, the controller 214 can update the inventory of the storage bin to reflect the removal of the first item from the storage bin. Additionally, in response to the controller 214 determining a second item was added to the storage bin, the controller 214 can update the inventory of the storage bin to reflect the addition of the second item to the storage bin.

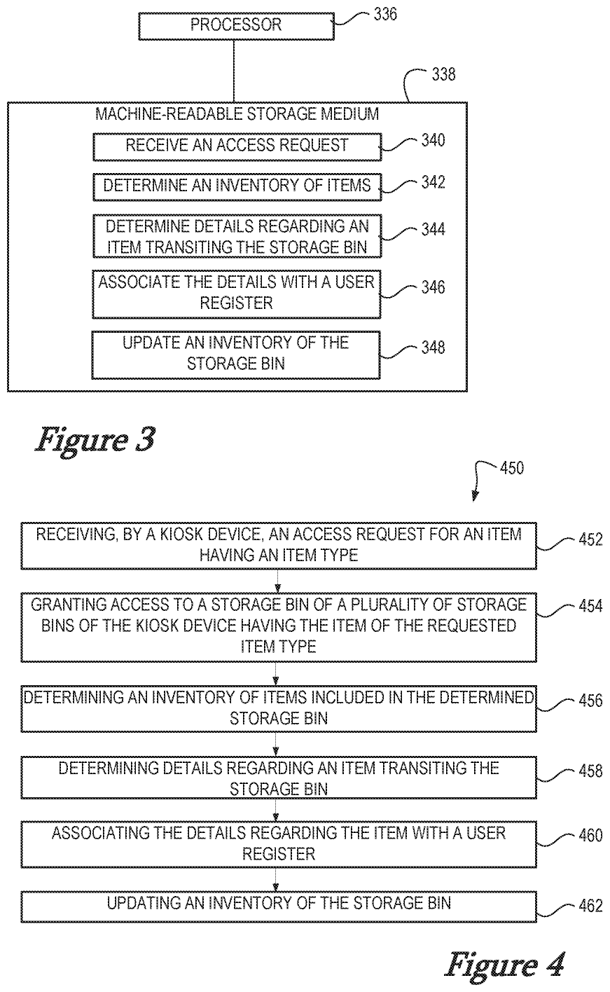

FIG. 3 illustrates a block diagram of an example system 334 consistent with the disclosure. In the example of FIG. 3, system 334 includes a processor 336 and a machine-readable storage medium 338. Although the following descriptions refer to a single processor and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processor 336 may be a central processing unit (CPU), microprocessor, and/or other hardware device suitable for retrieval and execution of instructions stored in machine-readable storage medium 338. In the particular example shown in FIG. 3, processor 336 may receive, determine, and send instructions 340, 342, 344, 346, and 348. As an alternative or in addition to retrieving and executing instructions, processor 336 may include an electronic circuit comprising a number of electronic components for performing the operations of the instructions in machine-readable storage medium 338. With respect to the executable instruction representations or boxes described and shown herein, it should be understood that part or all of the executable instructions and/or electronic circuits included within one box may be included in a different box shown in the figures or in a different box not shown.

Machine-readable storage medium 338 may be any electronic, magnetic, optical, or other physical storage device that stores executable instructions. Thus, machine-readable storage medium 338 may be, for example, Random Access Memory (RAM), an Electrically-Erasable Programmable Read-Only Memory (EEPROM), a storage drive, an optical disc, and the like. The executable instructions may be “installed” on the system 334 illustrated in FIG. 3. Machine-readable storage medium 338 may be a portable, external or remote storage medium, for example, that allows the system 334 to download the instructions from the portable/external/remote storage medium. In this situation, the executable instructions may be part of an “installation package”. As described herein, machine-readable storage medium 334 may be encoded with executable instructions associated with a kiosk device having storage bins.

Receive instructions 340, when executed by a processor such as processor 336, may cause system 334 to receive an access request to a storage bin of a kiosk device, where the access request is associated with a user identity. The access request can include an item type.

Determine instructions 342, when executed by a processor such as processor 336, may cause system 334 to determine, using an RFID reader of the kiosk device, an inventory of items included in the storage bin. The RFID reader can scan for (e.g., attempt to read) RFID tags associated with each item included in a storage bin. In response to the RFID reader reading RFID tags of each of the items included in the storage bin, the system 334 can determine an amount and type of items included in the storage bin.

Determine instructions 344, when executed by a processor such as processor 336, may cause system 334 to determine, via the RFID reader in response to the storage bin of the kiosk device being accessed, details regarding an item transiting the storage bin via an RFID tag associated with the item. For example, the system 334 can determine the details regarding an item transiting a storage bin of the storage bins including a type of an item, whether an item is removed from the storage bins, whether an item is added to the storage bins, an amount of the item added/removed, an allotment time of an item removed from the storage bins, costs associated with not returning an item removed from the storage bins, etc.

Associate instructions 346, when executed by a processor such as processor 336, may cause system 334 to associate the details regarding the item with a user register associated with the user identity. For example, the user register can include associated details regarding the item which can allow for easy inventory tracking of items included in the storage bins, whether they are being utilized, etc.

Update instructions 348, when executed by a processor such as processor 336, may cause system 334 to update an inventory of the storage bin based on the determined details regarding the item transiting the storage bin. For example, in response to the system 334 determining a first item was removed from the storage bin, the system 334 can update the inventory of the storage bin to reflect the removal of the first item from the storage bin. Additionally, in response to the system 334 determining a second item was added to the storage bin, the system 334 can update the inventory of the storage bin to reflect the addition of the second item to the storage bin.

FIG. 4 illustrates an example of a method 450 for a kiosk device having storage bins consistent with this disclosure. For example, method 450 can be performed by a kiosk device (e.g., kiosk device 102, previously described in connection with FIG. 1).

At 452, the method 450 includes receiving, by a kiosk device, an access request for an item having an item type. The access request can be associated with a user identity. The access request can include an item type.

At 454, the method 450 includes granting access, by the kiosk device, to a storage bin of the plurality of storage bins of the kiosk device having the item of the requested item type. For example, in response to the user identity having access rights to the storage bin(s), the kiosk device can grant access to the storage bin(s). In some examples in which a user may not have access rights to the storage bin(s), the kiosk device can deny access to the storage bin(s).

At 456, the method 450 includes determining an inventory of items included in the determined storage bin. The kiosk device can utilize an RFID reader of the kiosk device to determine the inventory of items included in the determined storage bin. For example, the RFID reader can scan for (e.g., attempt to read) RFID tags associated with each item included in the storage bin. In response to the RFID reader reading RFID tags of each of the items included in the storage bin, the kiosk device can determine an amount and type of items included in the storage bin.

At 458, the method 450 can include determining details regarding an item transiting the storage bin. The kiosk device can determine the details regarding the item transiting the storage bin via an RFID reader in response to the storage bin being accessed via an RFID tag associated with the item transiting the storage bin. For example, the kiosk device can determine the details regarding an item transiting a storage bin of the storage bins including a type of an item, whether an item is removed from the storage bins, whether an item is added to the storage bins, an amount of the item added/removed, an allotment time of an item removed from the storage bins, costs associated with not returning an item removed from the storage bins, etc.

At 460, the method 450 can include associating, by the kiosk device, the details regarding the item with a user register associated with the user identity. For example, the user register can include associated details regarding the item which can allow for easy inventory tracking of items included in the storage bins, whether they are being utilized, etc.

At 462, the method 450 can include updating, by the kiosk device, an inventory of the storage bin. The inventory of the storage bin can be updated based on the determined details regarding the item transiting the storage bin. For example, in response to the kiosk device determining a first item was removed from the storage bin, the kiosk device can update the inventory of the storage bin to reflect the removal of the first item from the storage bin. Additionally, in response to the kiosk device determining a second item was added to the storage bin, the kiosk device can update the inventory of the storage bin to reflect the addition of the second item to the storage bin.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense. As used herein, the designators “M”, “N”, and “O”, particularly with respect to reference numerals in the drawings, indicate that a plurality of the particular feature so designated can be included with examples of the disclosure. The designators can represent the same or different numbers of the particular features.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. A controller, comprising:
a processing resource; and
a memory resource storing non-transitory machine-readable instructions to cause the processing resource to:
determine, via a radio frequency identification (RFID) reader in response to a storage bin of a kiosk being accessed, details regarding an item transiting the storage bin via an RFID tag associated with the item based on a received access request for the storage bin that includes an associated user identity;
associate the details regarding the item with a user register associated with the user identity; and
update an inventory of the storage bin based on the determined details regarding the item transiting the storage bin.

2. The controller of claim 1, wherein in response to the item being removed from the storage bin, cause the processing resource to associate at least one of a time and a date the item was removed from the storage bin in the user register associated with the user identity.

3. The controller of claim 2, wherein in response to:
a first threshold amount of time passing since the item was removed from the storage bin, transmit a notification to a computing device associated with the user identity;
in response to a second threshold amount of time passing since the item was removed from the storage bin, generate a monetary charge in the user register associated with the user identity; and
in response to the item being added to the storage bin after the second threshold amount of time, modify the monetary charge in the user register associated with the user identity.

4. The controller of claim 1, including instructions to cause the processing resource to:
receive an RFID tag lost input indicating the RFID tag associated with the item is not attached to the item;
determine the details regarding the item by determining the item is conditionally added to the storage bin; and
transmit an RFID tag lost notification in response to receiving the RFID tag lost input.

5. The controller of claim 1, including instructions to cause the processing resource to transmit at least one of:
a re-stock notification in response to the updated inventory of the storage bin having an amount of items that is less than a threshold amount of items; and
a re-order notification in response to an item included in the storage bin having to be replaced.

6. The controller of claim 1, including instructions to cause the processing resource to cause the kiosk device to enter a kiosk device service mode, wherein an inventory of the storage bin is adjusted in the kiosk device service mode.

7. A non-transitory machine-readable storage medium storing instructions executable by a processor to cause the processor to:
receive an access request to a storage bin of a kiosk device, wherein the access request is associated with a user identity;
determine, using a radio frequency identification (RFID) reader of the kiosk device, an inventory of items included in the storage bin;
determine, via the RFID reader in response to the storage bin of the kiosk device being accessed, details regarding an item transiting the storage bin via an RFID tag associated with the item;
associate the details regarding the item with a user register associated with the user identity; and
update an inventory of the storage bin based on the determined details regarding the item transiting the storage bin.

8. The medium of claim 7, wherein:
the access request includes an item type; and
the instructions to determine the inventory of items further include instructions to determine an amount of the item type.

9. The medium of claim 8, comprising instructions to prevent access to the storage bin in response to the amount of the item type being less than a threshold amount.

10. The medium of claim 8, comprising instructions to prevent access to the storage bin in response to the item type not being included in the determined inventory of items included in the storage bin.

11. A method, comprising:
receiving, by a kiosk device, an access request for an item having an item type, wherein the access request is associated with a user identity;
granting access, by the kiosk device, to a storage bin of a plurality of storage bins of the kiosk device having the item of the requested item type;
determining, using a radio frequency identification (RFID) reader of the kiosk device, an inventory of items included in the determined storage bin;
determining, via the RFID reader in response to the storage bin being accessed, details regarding an item transiting the storage bin via an RFID tag associated with the item;
associating, by the kiosk device, the details regarding the item with a user register associated with the user identity; and
updating, by the kiosk device, an inventory of the storage bin based on the determined details regarding the item transiting the storage bin.

12. The method of claim 11, wherein the method includes:
assigning a pre-determined allotment time to the item in response to the item being removed from the storage bin; and
logging the pre-determined allotment time in the user register associated with the user identity.

13. The method of claim 12, wherein the method includes, in response to an amount of time passing that exceeds the pre-determined allotment time, at least one of:
transmitting, by the kiosk device, a notification to a computing device associated with the user identity; and
generating, by the kiosk device, a monetary charge in the user register associated with the user identity.

14. The method of claim 11, wherein the method includes generating, by the kiosk device, an alert in response to an item being removed from the storage bin that does not have the item type included in the access request.

15. The method of claim 11, wherein the method includes:
receiving, by the kiosk device, a reservation request for the item, wherein the reservation request is associated with a different user identity; and
preventing, by the kiosk device, access to the determined storage bin in response to the access request being for the item having the reservation request.
